(19) United States
(12) Patent Application Publication
(10) Pub. No.: US 2026/0070027 A1
(43) Pub. Date: Mar. 12, 2026

(54) Hollow-Fiber Membrane Made From A Polymeric Blend Comprising An Aromatic Sulfone Polymer And Polyoxazoline

(71) Applicant: Solventum Intellectual Properties Company, Maplewood, MN (US)

(72) Inventors: Christian Krumm, Solingen (DE); Ramona Osterloh, Velbert (DE); Amy S. Determan, Mahtomedi, MN (US); Manfred Trussner, Radevormwald (DE); Mathias Stroschke, Sprockhoevel (DE)

(21) Appl. No.: 19/106,194

(22) PCT Filed: Aug. 17, 2023
(86) PCT No.: PCT/IB2023/058251

§ 371 Date: Feb. 24, 2025

Related U.S. Application Data
(60) Provisional application No. 63/400,679, filed on Aug. 24, 2022.

(51) Int. Cl. B01D 71/68; B01D 69/08; B01D 71/44; B01D 71/58

(52) U.S. Cl. CPC B01D 71/68; B01D 69/081; B01D 69/082; B01D 71/441; B01D 71/58; B01D 2325/02833

(57) ABSTRACT

A hollow-fiber membrane. The hollow-fiber membrane is made from a polymeric blend comprising an aromatic sulfone polymer and polyoxazoline, wherein the polymeric blend comprises from 27 wt. % to 30 wt. % aromatic sulfone polymer, based on the total weight of the polymeric blend; wherein the hollow-fiber membrane comprises an inner surface facing towards its lumen, an outer surface facing outwards and an intermediate wall having a wall thickness; wherein the hollow-fiber membrane is an integrally asymmetric, permeable hollow-fiber membrane.

### FIELD

The present disclosure relates to porous membranes. In addition, the present disclosure relates to a process for producing such membranes. The present disclosure further relates to use of such membranes for filtration and purification of liquid media.

### BACKGROUND

Hollow-fiber membranes are employed in a very wide range of different industrial, pharmaceutical or medical applications for precision filtration. In these applications, membrane separation processes are gaining in importance, as these processes offer the advantage that the substances to be separated are not thermally burdened or even damaged. Ultrafiltration membranes can be employed for the removal or separation of macromolecules. Numerous further applications of membrane separation processes are known from the beverages industry, biotechnology, water treatment or sewage technology. Such membranes are generally classified according to their retention capacity, i.e. according to their capacity for retaining particles or molecules of a certain size, or with respect to the size of the effective pores, i.e. the size of the pores that determine the separation behavior. Ultrafiltration membranes thereby cover the size range of the pores determining the separation behavior between roughly 0.01 and approx. 0.1 μm, so that particles or molecules with a size in the range larger than 20 000 or larger than approx. 200 000 Daltons can be retained. There is a need for better polymer membranes.

### SUMMARY

Thus, in one aspect, the present disclosure provides a hollow-fiber membrane; the hollow-fiber membrane made from a polymeric blend comprising an aromatic sulfone polymer and a polyoxazoline, wherein the polymeric blend comprises from 27 wt. % to 30 wt. % aromatic sulfone polymer, based on the total weight of the polymeric blend; wherein the hollow-fiber membrane comprises an inner surface facing towards its lumen, an outer surface facing outwards and an intermediate wall having a wall thickness; wherein the hollow-fiber membrane is an integrally asymmetric, permeable hollow-fiber membrane.

In another aspect, the present disclosure provides a use of the hollow-fiber membrane of the present disclosure for filtration of antibodies.

In another aspect, the present disclosure provides a method, comprising of flowing an antibody containing solution through the hollow-fiber membrane of any of claims; and collecting the antibody.

Various aspects and advantages of exemplary embodiments of the present disclosure have been summarized. The above Summary is not intended to describe each illustrated embodiment or every implementation of the present disclosure. Further features and advantages are disclosed in the embodiments that follow. The Drawings and the Detailed Description that follow more particularly exemplify certain embodiments using the principles disclosed herein.

### BRIEF DESCRIPTION OF THE DRAWINGS

FIG. 1 is a schematic perspective view, in partial cross-section of an exemplary hollow-fiber membrane.

FIG. 2 is a cross-section of an exemplary hollow-fiber membrane.

FIG. 3A is SEM picture of 4,000× magnification of cross-section of a hollow-fiber membrane according to the present disclosure.

FIG. 3B is SEM picture of 20,000× magnification of a crossed region of FIG. 3A.

### DETAILED DESCRIPTION

Before any embodiments of the present disclosure are explained in detail, it is understood that the invention is not limited in its application to the details of use, construction, and the arrangement of components set forth in the following description. The invention is capable of other embodiments and of being practiced or of being carried out in various ways that will become apparent to a person of ordinary skill in the art upon reading the present disclosure. Also, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. It is understood that other embodiments may be utilized and structural or logical changes may be made without departing from the scope of the present disclosure.

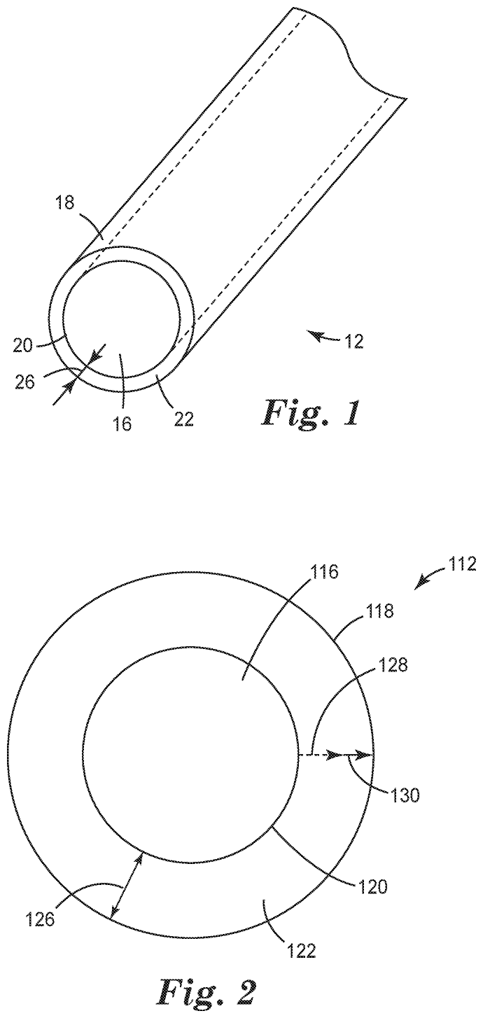

One embodiment of a hollow-fiber membrane according to the present disclosure is shown in FIG. 1. FIG. 1 illustrates a perspective view of a partial cross-section of a portion of an exemplary hollow-fiber membrane 12. Hollow-fiber membrane 12 may have a continuous hollow lumen 16, which extends from one end to the other end of the fiber, an outer surface 18 facing outwards, which forms an outer side of the fiber, an inner surface 20 facing towards the hollow lumen 16, which defines the limits of the continuous hollow lumen 16; and an intermediate wall 22 having a wall thickness 26. The hollow-fiber membrane 12 can be made from a polymeric blend comprising an aromatic sulfone polymer and a polyoxazoline. The hollow-fiber membrane can be an integrally asymmetric, permeable hollow-fiber membrane.

The wall thickness 26, measured between the outer surface 18 and the inner surface 20 of the hollow-fiber membrane 12, can be in the range of from 20 to 300 μm, from 30 to 200 μm, or from 40 to 80 μm.

Similarly, in order to achieve a desirable flow through the human of the hollow-fiber membranes according to the present disclosure, particularly, a favorable pressure drop, it is preferred that the inside diameter of the hollow-fiber membranes as described herein is in the range of from 50 to 800 μm, from 50 to 700 μm, from 50 to 600 μm, from 100 to 500 μm, from 100 to 400 μm, or from 100 to 300 μm. Wall thicknesses and diameters (i.e., inner or lumen diameter, and outer diameter) of the membranes as described herein are also determined by means of conventional examination methods, such as using scanning or transmission electron micrographs (SEM or TEM, respectively), for example with a magnification up to 20,000:1. In some embodiments, the hollow-fiber membrane can have tortuous structures extending from the inner surface toward to the outer surface. In some embodiments, the hollow-fiber membrane can have tortuous structures or paths extending through the entire membrane wall. These tortuous structures can, for example, help the membrane retain larger viral contaminants and allow smaller biopharmaceuticals (such as monoclonal antibodies (mAb)) to pass through the membrane. These tortuous structures can increase the possibility to capture the viral contaminants while maintaining a high mAb throughput. When the hollow-fiber membrane has tortuous structures, it may have a low number of structural defects, i.e. closed cells or macrovoids. The inner upstream side of the membranes feature a porous surface, which is build up by isotropic nodular structures. When pore compartments are connected in the membrane and therefore have torturous morphology in place, the hollow-fiber membranes may have high trans membrane flow (TMF).

In some embodiments, the hollow-fiber membrane may have two zones: the zone with minimum pore size and the zone with maximum pore size. In some embodiments, the zone with minimum pore size adjoins the inner surface. In some of those embodiments, the zone with maximum pore size adjoins the outer surface. In other embodiments, the zone with minimum pore size adjoins the outer surface. In some of these embodiments, the zone with maximum pore size adjoins to the inner surface. “Adjoin” means that the zone of maximum or minimum pore size is located at a distance from the surface in the range between 0 to 8 μm. In some embodiments, the size of the pores in the zone with minimum pore sizes can be in the range of from 10 nm to 100 nm, from 10 nm to 90 nm, from 10 nm to 80 nm, from 10 nm to 70 nm, from 10 nm to 60 nm, from 10 nm to 50 nm, from 10 nm to 40 nm, from 10 nm to 30 nm, from 10 nm to 20 nm, from 20 nm to 80 nm, from 20 nm to 70 nm, from 20 nm to 60 nm, from 20 nm to 50 nm, from 30 nm to 70 nm, from 30 nm to 60 nm, from 30 nm to 50 nm, from 30 nm to 40 nm, from 40 nm to 90 nm, from 40 nm to 80 nm, from 40 nm to 70 nm, from 40 nm to 60 nm, or from 40 nm to 50 nm. In some embodiments, the size of the pores in the zone with minimum pore size can be less than 100 nm, 90 nm, 80 nm, 70 nm, 60 nm, 50 nm, 40 nm, 30 nm, or 20 nm. In some embodiments, the size of the pores in the zone with minimum pore size can be more than 10 nm, 15 nm, 20 nm, or 25 nm. In some embodiments, the size of the pores in the zone with maximum pore size can be in the range of from 0.05 μm to 10 μm. The average pore size of the zones with maximum pore size is larger than the average pore size of the zones with minimum pore size. The zone with minimum pore size can form a retention layer. When the zone with minimum pore size adjoins the outer surface, the retention layer adjoins the outer surface of the membrane and can form a more conducive membrane structure for filtering liquids, for example, biopharmaceuticals. In some embodiments, at least some pores of the zone with minimum pore size or the zone with maximum pore size may be connected, for example, through channels between pores. These connected pores may form void spaces in the hollow-fiber membrane so that these void spaces can help retain larger viral contaminants, allow smaller biopharmaceuticals (such as mAb) to pass through the membrane and facilitate collecting sample, such as mAb after filtration. In some embodiments, the hollow-fiber membrane comprises tortuous structures extending in the hollow-fiber membrane, for example, from the inner surface toward to the outer surface. In some embodiments the hollow-fiber membrane has a first zone of pores and a second zone of pores, wherein the first zone of pores adjoins the inner surface, and the second zone of pores adjoins the outer surface, and the density of pores in the first zone is greater than the density of pores in the second zone. In some embodiments the hollow-fiber membrane has a first zone of pores and a second zone of pores, wherein the first zone of pores adjoins the inner surface, and the second zone of pores adjoins the outer surface, and the density of pores in the second zone is greater than the density of pores in the first zone. In some embodiments, the zone with minimum pore size has a lower flow rate than the zone with maximum pore size.

Average pore diameter or pore size of the pores can be determined, for example, by the method described in US 2017/0304780 (Asahi et al.) Average pore diameter or pore size of the pores can be determined by photographing a cross-section of the hollow fiber by a scanning electron microscope (SEM). For example, the photographing magnification is set at 50,000×, and the field of view is set on a cross-section perpendicular to the length direction of the hollow fiber or a cross-section parallel to the length direction and passing through the center of the hollow portion, horizontally to the cross-section. After photographing the set field of view, the photographing field of view is moved horizontally in the membrane thickness direction, and the next field of view is photographed.

This photographing operation is repeated until photographs of the cross-section of the membrane crossing from the outer surface to the inner surface are taken without a gap, and the obtained photographs am combined to obtain one membrane cross-section photograph. In this cross-section photograph, the average pore diameter of the pores in each area of (2 μm in the circumferential direction of the membrane)×(1 μm from the outer surface toward the inner surface side) from the outer surface toward the inner surface side is calculated, and the gradient structure of the membrane cross-section is quantified for each 1 μm from the outer surface toward the inner surface side. By such quantification, it can be determined as to whether or not the membrane has a gradient-type porous structure.

The average pore diameter or pore size can be calculated by a method using image analysis. The identification between a pore portion and a solid portion is based on their brightness, and a portion that cannot be identified and noise are corrected by a free hand tool. After the binarization processing, the diameter of a pore is calculated from the area value of the pore assuming that the pore is a perfect circle. The calculation is carried out for all pores, and the average pore diameter is calculated for each area of 1 μm×2 μm. A pore portion that is located at the end of the field of view and is partially in the field of view is also counted (i.e. its diameter is calculated assuming that the area of a pore portion partially in the field of view is the area of one whole perfect circle).

Another embodiment of a hollow-fiber membrane according to the present disclosure is shown in FIG. 2. FIG. 2 illustrates a cross-section view of an exemplary hollow-fiber membrane 112. Hollow-fiber membrane 112 may have a continuous hollow lumen 116, which extends from one end to the other end of the fiber, an outer surface 118 facing outwards, which forms an outer side of the fiber, an inner surface 120 facing towards the hollow lumen 116, which defines the limits of the continuous hollow lumen 116; and an intermediate wall 122 having a wall thickness 126. Hollow-fiber membrane 112 may have a first cross section zone 128 that begins at the inner surface 120 and extends (in some embodiments, laterally) into the interior of the intermediate wall 122 terminating at an internal distance within the intermediate wall 122. In the first cross section zone 128, the pore size progressively decreases in the direction of the arrow (i.e. the pore size progressively decreases across the first cross section zone in the direction from the inner surface 120 to the outer surface 118 for a distance intermediate between the inner and outer surfaces with the measurement of pore sizes being made along a vector that defines the shortest cross-section distance from the inner surface of the membrane to the outer surface of the membrane).

Hollow-fiber membrane 112 may have a second cross section zone 130 that begins at the location where the first cross section zone terminates and extends (in some embodiments, laterally) to the outer surface 118 of the membrane. In the second cross section zone 130, the pore size progressively increases in the direction of the arrow (i.e., the pore size progressively increases across the second cross section zone 130 in the direction from the beginning of the second cross section zone in the interior of the wall to the outer surface 118 with the measurement of pore sizes being made along a vector that defines the shortest cross-section distance from the beginning of the second cross section zone to the outer surface 118 of the membrane). In some embodiments, the pore size at the outer surface 118 may be smaller than the pore size at the inner surface 120.

The location in the interior of the wall 122 where the first cross section zone 128 terminates and the second cross section zone begins is defined as the transition location.

In some embodiments of hollow-fiber membrane shown in FIG. 2, the pore size in the first cross section zone 128 progressively decreases in the direction of the arrow (i.e., the pore size progressively decreases across the first cross section zone 128 in the direction from the inner surface 120 to the outer surface 118 for a distance of about 10%, 15%, 20%, 25%, 30%, 35%, 40%, 45%, 50%, 55%, 60%, 65%, 70%, 75%, 80%, 85%, 90%, 95% or 98% across the membrane wall with the measurement of pore sizes being made along a vector that defines the shortest cross-section distance from the inner surface of the membrane to the outer surface of the membrane). In the second cross section zone 130, the pore size progressively increases in the direction of the arrow (i.e., the pore size progressively increases across the second cross section zone in the direction from the beginning of the second cross section zone in the interior of the wall to the outer surface 118 with the measurement of pore sizes being made along a vector that defines the shortest cross-section distance from the beginning of the second cross section zone 130 to the outer surface 118 of the membrane). The pore size at the outer surface 118 may be smaller than the pore size at the inner surface 112.

In some embodiments of hollow-fiber membrane shown in FIG. 2, the pore size of the first cross section zone 128 progressively decreases in the direction of the arrow (i.e., the pore size progressively decreases across the first cross section zone in the direction from the inner surface 120 to the outer surface 118 for a distance of about 10%, 15%, 20%, 25%, 30%, 35%, 40%, 45%, 50%, 55%, 60%, 65%, 70%, 75%, 80%, 85%, 90%, or 95% across the membrane wall with the measurement of pore sizes being made along a vector that defines the shortest cross-section distance from the inner surface of the membrane to the outer surface of the membrane). In the second cross section zone 130, the pore size progressively increases in the direction of the arrow (i.e., the pore size progressively increases across the second cross section zone in the direction from the beginning of the second cross section zone in the interior of the wall to the outer surface 118 with the measurement of pore sizes being made along a vector that defines the shortest cross-section distance from the beginning of the second cross section zone to the outer surface 118 of the membrane).

The pore size at the outer surface 118 may be about 0.05 to 0.5 micrometers and the pore size at the inner surface 112 may be about 0.05 to 5 micrometers.

In some embodiments of hollow-fiber membrane shown in FIG. 2, the pore size of the first cross section zone 128 progressively decreases in the direction of the arrow (i.e., the pore size progressively decreases across the first cross section zone in the direction from the inner surface 120 to the outer surface 118 for a distance of about 10%, 15%, 20%, 25%, 30%, 35%, 40%, 45%, 50%, 55%, 60%, 65%, 70%, 75%, 80%, 85%, 90%, 95%, or 98% across the membrane wall with the measurement of pore sizes being made along a vector that defines the shortest cross-section distance from the inner surface of the membrane to the outer surface of the membrane). In the second cross section zone 130, the pore size progressively increases in the direction of the arrow (i.e., the pore size progressively increases across the second cross section zone in the direction from the beginning of the second cross section zone in the interior of the wall to the outer membrane surface with the measurement of pore sizes being made along a vector that defines the shortest cross-section distance from the beginning of the second cross section zone to the outer surface 118 of the membrane). The pore size at the outer surface 118 may be about 0.05 to 0.5 micrometers, the pore size at the inner surface 112 may be about 0.05 to 5 micrometers, and the pore size at the transition location may be about 0.015 to 0.035 micrometers.

In some embodiments of hollow-fiber membrane shown in FIG. 2, the pore size in the first cross section zone 128 progressively decreases in the direction of the arrow (i.e. the pore size progressively decreases across the first cross section zone in the direction from the inner surface 120 to the outer surface 118 for a distance of about 10%-20%, 20%-30%, 30%-40%, 40%-50%, 50%-60%, 60%-70%, 70%-80%, 80%-90%, or 90%-95% across the membrane wall with the measurement of pore sizes being made along a vector that defines the shortest cross-section distance from the inner surface of the membrane to the outer surface of the membrane.

The pore size at the transition location (i.e., the location where the first cross section zone ends and transitions into the start of the second cross section zone) may form at least a portion of a retention layer or retention zone in the hollow-fiber membrane. The retention layer or retention zone is the section of a hollow-fiber membrane with the greatest (i.e., maximum) capability or capacity to capture small contaminant components of the liquid sample when it is filtered through the membrane. Typically, the liquid sample to be filtered through the hollow-fiber membrane contains desired components that are preferably collected post-filtration in the filtrate and contaminant components that are preferably captured by the membrane. The retention layer or retention zone principally filters contaminants from the liquid sample based on differences in the size of contaminants and desired components. The desired component or components in the liquid sample are of a size that can pass through the retention layer or zone and be collected in the filtrate resulting in a purified liquid sample. For example, in a liquid sample containing both antibodies and viruses, large viruses (typically 15-30 nm in diameter) can be separated from smaller antibodies (typically 5-10 nm in diameter) when the liquid sample passes through the retention layer or zone. The virus component of the liquid sample can be preferentially retained in the retention layer or zone, while the antibody component of the liquid sample can pass through the retention layer or zone and be collected in the filtrate. In some embodiments, the zone with minimum pore size (retention layer) has a thickness of 5 to 100 μm, 10 to 90 μm, 20 to 80 μm, 30 to 70 μm, or 40 to 60 μm.

In some embodiments, the pore size at the transition location is less than 0.04 micrometers, less than 0.035 micrometers, or less than 0.03 micrometers.

In some embodiments, the pore size at the transition location is about 0.01 to 0.04 micrometers, 0.01 to 0.035 micrometers, 0.01 to 0.03 micrometers, 0.015 to 0.04 micrometers, 0.015 to 0.035 micrometers, or 0.015 to 0.03 micrometers.

In some embodiments of hollow-fiber membrane shown in FIG. 2, the pore size in the first cross section zone 128 progressively decreases in the direction of the arrow (i.e., the pore size progressively decreases across the first cross section zone in the direction from the inner surface 120 to the outer surface 118 to a distance 3 to 50 micrometers from the outer surface With the measurement of pore sizes being made along a vector that defines the shortest cross-section distance from the inner surface of the membrane to the outer surface of the membrane). In the second cross section zone 130, the pore size progressively increases in the direction of the arrow (i.e. the pore size progressively increases across the second cross section zone in the direction from beginning of the second cross section zone in the interior of the wall to the outer membrane surface 118 with the measurement of pore sizes being made along a vector that defines the shortest cross-section distance from the beginning of the second cross section zone to the outer surface 118 of the membrane). The pore size at the outer surface 118 may be smaller than the pore size at the inner surface 120.

In some embodiments of hollow-fiber membrane shown in FIG. 2, the pore size in the first cross section zone 128 progressively decreases across the first cross section zone in the direction from the inner surface 120 to the outer surface 118 to a distance 3 to 15 micrometers from the outer surface with the measurement of pore sizes being made along a vector that defines the shortest cross-section distance from the inner surface of the membrane to the outer surface of the membrane.

In some embodiments of hollow-fiber membrane shown in FIG. 2, the pore size in the first cross section zone 128 progressively decreases across the first cross section zone in the direction from the inner surface 120 to the outer surface 118 to a distance 3 to 8 micrometers from the outer surface with the measurement of pore sizes being made along a vector that defines the shortest cross-section distance from the inner surface of the membrane to the outer surface of the membrane.

In some embodiments of hollow-fiber membrane shown in FIG. 2, the hollow-fiber membrane wall thickness is 30 to 100, 40 to 90, or 50 to 65 micrometers and the pore size of the membrane at the inner surface facing the lumen progressively decreases across the first cross section zone 128 in the direction from the inner surface 120 to the outer surface 118 to a distance 3 to 50 micrometers from the outer surface With the measurement of pore sizes being made along a vector that defines the shortest cross-section distance from the inner surface of the membrane to the outer surface of the membrane. In the second cross section zone 130, the pore size progressively increases in the direction of the arrow (i.e., the pore size progressively increases across the second cross section zone in the direction from the beginning of the second cross section zone in the interior of the wall to the outer surface 118 with the measurement of pore sizes being made along a vector that defines the shortest cross-section distance from the beginning of the second cross section zone to the outer surface 118 of the membrane). The pore size at the outer surface 118 may be smaller than the pore size at the inner surface 120.

In some embodiments of hollow-fiber membrane shown in FIG. 2, the hollow-fiber membrane wall thickness is 30 to 100, 40 to 90, or 50 to 65 micrometers and the pore size of the membrane at the inner surface facing the lumen progressively decreases across the first cross section zone 128 in the direction from the inner surface 120 to the outer surface 118 to a distance 3 to 50 micrometers from the outer surface with the measurement of pore sizes being made along a vector that defines the shortest cross-section distance from the inner surface of the membrane to the outer surface 118 of the membrane.

In some embodiments of hollow-fiber membrane shown in FIG. 2, the hollow-fiber membrane wall thickness is 30 to 100, 40 to 90, or 50 to 65 micrometers and the pore size of the membrane at the inner surface facing the lumen progressively decreases across the first cross section zone 128 in the direction from the inner surface 120 to the outer surface 118 to a distance 3 to 15 micrometers from the outer surface with the measurement of pore sizes being made along a vector that defines the shortest cross-section distance from the inner surface of the membrane to the outer surface 118 of the membrane.

In some embodiments of hollow-fiber membrane shown in FIG. 2, the hollow-fiber membrane wall thickness is 30 to 100, 40 to 90, or 50 to 65 micrometers and the pore size of the membrane at the inner surface facing the lumen progressively decreases across the first cross section zone 128 in the direction from the inner surface 120 to the outer surface 118 to a distance 3 to 8 micrometers from the outer surface with the measurement of pore sizes being made along a vector that defines the shortest cross-section distance from the inner surface of the membrane to the outer surface 118 of the membrane.

In some embodiments, the pore size at the outer surface is about 0.05 to 2 micrometers, 0.05 to 1 micrometers, or 0.05 to 0.5 micrometers,

In some embodiments, the pore size at the inner surface is about 0.05 to 5 micrometers.

In some embodiments, the pore size at the outer surface is 0.05 to 0.5 micrometers, the pore size at the inner surface is about 0.05 to 5 micrometers, and the pore size at the transition location is about 0.015 to 0.04 micrometers.

In some embodiments, the pore size at the outer surface is 0.05 to 0.5 micrometers, the pore size at the inner surface is about 0.05 to 5 micrometers, and the pore size at at the transition location is about 0.015 to 0.035 micrometers.

In some embodiments, the pore size at the outer surface is about 0.05 to 0.5 micrometers, the pore size at the inner surface is about 0.05 to 5 micrometers, and the pore size at at the transition location is about 0.015 to 0.03 micrometers.

In some embodiments, hollow-fiber membrane wall thickness is 30 to 100 micrometers, the pore size at the outer surface is about 0.05 to 2 micrometers, the pore size at the inner surface is about 0.05 to 5 micrometers, and the minimum or smallest pore size in the membrane is about 0.015 to 0.035 micrometers.

In some embodiments, hollow-fiber membrane wall thickness is 30 to 100 micrometers, the pore size at the outer surface is about 0.05 to 1 micrometers, the pore size at the inner surface is about 0.05 to 5 micrometers, and the minimum or smallest pore size in the membrane is about 0.015 to 0.035 micrometers.

In some embodiments, hollow-fiber membrane wall thickness is 30 to 100 micrometers, the pore size at the outer surface is about 0.05 to 0.5 micrometers, the pore size at the inner surface is about 0.05 to 5 micrometers, and the minimum or smallest pore size in the membrane is about 0.015 to 0.035 micrometers.

The aromatic sulfone polymer of the present disclosure, e.g. polysulfones, polyethersulfones, polyphenylene sulfones, polyarylethersulfones or copolymers or modifications of these polymers or mixtures of these polymers can be used. In a preferred embodiment, the aromatic sulfone polymer can be a polysulfone or a polyethersulfone with the repeating molecular units shown in formulas (I) and (II) as follows:

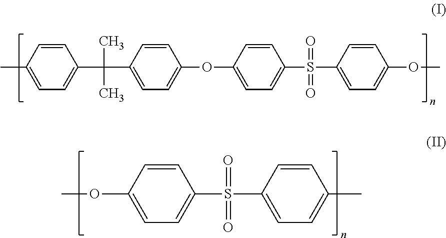

More preferably, a polyethersulfone according to formula (II) is used as the aromatic sulfone polymer, because this has lower hydrophobicity than, for example, the polysulfone. The polysulfone may have a molecular weight of about 72 kg/mol.

In some embodiments, the aromatic sulfone polymer can be present in a concentration of 27 wt. % to 30 wt. %, 27 wt. % to 29 wt. %, 27 wt. % to 28 wt. %, 28 wt. % to 30 wt. %, or 28 wt. % to 29 wt. % based on the total weight of the polymeric blend, 27 wt. % to 30 wt. % aromatic sulfone polymer is important for the membrane having a pore size below 30 nm intended to remove viruses/phages (20-30 nm) from monoclonal antibodies (5-10 nm) solutions.

In some embodiments of the polymeric blend, the polyoxazoline can be present in a concentration of 1 wt. % to 35 wt. %, 5 wt. % to 35 wt. %, 5 wt. % to 30 wt. %, 5 wt. % to 25 wt. %, 5 wt. % to 20 wt. %, 5 wt. % to 15 wt. %, 7 wt. % to 15 wt. %, 7 wt. % to 12 wt. %, or 8 wt. % to 11 wt. % based on the total weight of the polymeric blend.

In some embodiments of the polymeric blend, the polyoxazoline can be present in a concentration of 8 wt. % to 11 wt. % based on the total weight of the polymeric blend.

In some embodiments, the polyoxazoline of the present disclosure can be a poly(2-oxazoline). Poly(2-oxazolines) can be prepared by cationic ring opening polymerization reactions of various 2-oxazoline monomers. Polymerization of 2-alkyl substituted 2-oxazoline monomers provides poly(2-alkyl-2-oxazolines)

In some embodiments, the poly(2-oxazoline) of the present disclosure can be poly(2-ethyl-2-oxazoline) (PEtOx). Poly(2-oxazolines) have high potential for protein repulsion. The residual groups of poly(2-oxazolines) can be changed, to alter the properties of the polymers, e.g. from hydrophilic to hydrophobic. The poly(2-oxazolines) may have a molecular weight of from about 25 kg/mol to about 500 kg/mol. The poly(2-oxazoline) may have a molecular weight of about 50 kg/mol.

The poly(2-ethyl-2-oxazoline) can have a molecular weight of from about 25 kg/mol to about 500 kg/mol. The poly(2-ethyl-2-oxazoline) can have a molecular weight of from about 25 kg/mol to about 100 kg/mol. The poly(2-ethyl-2-oxazoline) can have a molecular weight of about 50 kg/mol.

The poly(2-oxazoline) can be present in a concentration of 0.5 to 30 wt. %, 1 to 30 wt. %, 5 to 30 wt. %, or 10 to 30 wt. % relative to the weight of the membrane. The poly(2-oxazolines) can be present in a concentration of more than 0.5 wt. %, more than 1 wt. %, more than 2 wt. %, more than 3 wt. %, more than 4 wt. %, more than 5 wt. %, more than 6 wt. %, more than 7 wt. %, more than 8 wt. %, more than 9 wt. %, more than 10 wt. %, more than 15 wt. %, or more than 20 wt. % relative to the weight of the membrane. The poly(2-oxazolines) can be present in a concentration of less than 30 wt. %, less than 28 wt. %, less than 25 wt. %, less than 23 wt. %, less than 20 wt. %, less than 15 wt. %, or less than 10 wt. % relative to the weight of the membrane. In some embodiments, the wt. % ratio of aromatic sulfone polymer to poly(2-oxazoline) in the membrane can be from 4:1 to 25:1, from 4:1 to 10:1, from 5:1 to 10:1, from 10:1 to 15:1, from 15:1 to 20:1, or from 20:1 to 25:1.

The aromatic sulfone polymer and the poly(2-oxazoline) may be distributed throughout the membrane. The aromatic sulfone polymer and the poly(2-oxazoline) may be evenly distributed throughout the membrane. The aromatic sulfone polymer and the poly(2-oxazoline) may be uniformly distributed throughout the membrane.

In some embodiments, the poly(2-oxazoline) may be distributed throughout the membrane. The poly(2-oxazoline) may be distributed throughout the membrane. The poly(2-oxazoline) may be evenly distributed throughout the membrane. In some embodiments, the poly(2-oxazoline) may be uniformly distributed throughout the membrane. Poly(2-ethyl-2-oxazoline) may be distributed throughout the membrane. In some embodiments, poly(2-ethyl-2-oxazoline may be evenly distributed throughout the membrane. In some embodiments, poly(2-ethyl-2-oxazoline) may be uniformly distributed throughout the membrane. In some embodiments, poly(2-oxazoline) may not be evenly distributed throughout the membrane. In some embodiments, poly(2-ethyl-2-oxazoline) may not be uniformly distributed throughout the membrane. For example, the concentration of poly(2-ethyl-2-oxazoline) at or adjoining the outer surface may be more than the concentration of poly(2-ethyl-2-oxazoline) at or adjoining the inner surface.

In some embodiments, the polymeric blend may further include an additional hydrophilic polymer. Exemplary hydrophilic polymer can include polyvinylpyrrolidone, polyethylene glycol, glycerol, polyvinyl alcohol, polyglycol monoester, polysorbitate, carboxymethylcellulose, polyacrylic acid, polyacrylate, or a modification or a copolymer of these polymers. In some embodiments, the hydrophilic polymer can be polyethylene glycol. In some embodiments, the polymeric blend does not comprise polyvinylpyrrolidone.

In some embodiments, the hydrophilic polymer can be present in a concentration of 1 to 75 wt. % relative to the weight of the membrane. In some embodiments, the polymeric blend can include more than 7 wt. %, more than 10 wt. %, more than 20 wt. %, more than 30 wt. %, more than 40 wt. %, more than 50 wt. %, or more than 60 wt. % of polyvinylpyrrolidone. In some embodiments, the polymeric blend can include less than 3 wt. %, less than 2 wt. % or less than 1 wt. % of polyvinylpyrrolidone.

In some embodiments, the polymeric blend may include a solvent and non-solvents. Exemplary blends can include glycol, glycerol, butyrolactone, ε-caprolactam, N-methyl pyrrolidone, water or combination thereof.

In some embodiments, the polymeric blend can have 5-18 wt. % of poly(2-ethyl-2-oxazoline) based on the total weight of the polymeric blend. In some embodiments, the polymeric blend can have 5-15 wt. % of poly(2-ethyl-2-oxazoline) based on the total weight of the polymeric blend. In some embodiments, the polymeric blend can have 7-12 wt. % of poly(2-ethyl-2-oxazoline) based on the total weight of the polymeric blend. In some embodiments, the polymeric blend can have 8-11 wt. % of poly(2-ethyl-2-oxazoline) based on the total weight of the polymeric blend.

In some embodiments, the polymeric blend can have 25-60 wt. % of N-methylpyrrolidone based on the total weight of the polymeric blend. In some embodiments, the polymeric blend can have 25-50 wt. % of N-methylpyrrolidone, based on the total weight of the polymeric blend. In some embodiments, the polymeric blend can have 25-40 wt. % of N-methylpyrrolidone, based on the total weight of the polymeric blend.

In some embodiments, the polymeric blend can have 27-30 wt. % of a polyethersulfone and 5-15 wt. %, of poly(2-ethyl-2-oxazoline) based on the total weight of the polymeric blend. In some embodiments, the polymeric blend can have 27-30 wt. % of a polyethersulfone and 7-12 wt. % of poly(2-ethyl-2-oxazoline) based on the total weight of the polymeric blend.

In some embodiments, the polymeric blend can have 20-40 wt. % of a polyethylene glycol based on the total weight of the polymeric blend. In some embodiments, the polymeric blend can have 25-35 wt. % of a polyethylene glycol based on the total weight of the polymeric blend.

In some embodiments, the polymeric blend can have 27-30 wt. % of a polyethersulfone; 5-15 wt. % of poly(2-ethyl-2-oxazoline); 30-40 wt. % of N-methylpyrrolidone; and 5-40 wt. % of a polyethylene glycol based on the total weight of the polymeric blend.

In some embodiments, the polymeric blend can have 27-30 wt. % of a polyethersulfone; 7-12 wt. % of poly(2-ethyl-2-oxazoline); 30-35 wt. % of N-methylpyrrolidone; and 25-35 wt. % of a polyethylene glycol based on the total weight of the polymeric blend.

It is also preferred that the wall thickness of the hollow-fiber membranes as disclosed herein is in the range of from 10 to 400 μm, from 20 to 300 μm, from 30 to 200 μm, or from 40 to 80 μm. At a wall thickness less than 20 μm, the mechanical properties of the hollow-fiber membrane may fall below a certain desirable level, while at wall thicknesses above 400 μm, the trans membrane flow decreases. Similarly, in order to achieve a desirable flow through the lumen of the hollow-fiber membranes according to the present disclosure, particularly, a favorable pressure drop, it is preferred that the inside diameter of the hollow-fiber membranes as described herein is in the range of from 50 to 800 μm, from 50 to 700 μm, from 50 to 600 μm, from 100 to 500 μm, from 100 to 400 μm, or from 100 to 300 μm.

The hollow-fiber membranes according to the present invention preferably exhibit a trans membrane flow for water of at least 0.01 mL/(cm²·min·bar), preferably at least 0.1 mL/(cm²·min·bar), more preferably at least 0.15 mL/(cm²·min·bar), and even more preferably at least 0.2 mL/(cm²·min·bar). This ensures an adequate and stable filtration capacity in the application. It is further preferred that the hollow-fiber membranes as disclosed herein exhibit a trans membrane flow for water in the range of from 0.01 to 10 mL/(cm²·min-bar), preferably from 0.15 to 5 mL/(cm²·min-bar), and more preferably from 0.1 to 3 mL/(cm²·min·bar). Trans membrane flows in these ranges allow for adequate and stable filtration capacity in suitable applications without deteriorating the retention capacity or compromising the mechanical stability. The trans membrane flow is preferably determined as described in the experimental section.

The hollow-fiber membranes according to the present disclosure can be made by methods disclosed in WO 2019/229667 A1 (Malek et al.), which is incorporated herein by reference in its entirety into this disclosure. A polymeric blend comprising an aromatic sulfone polymer and a polyoxazoline can be selected as the spinning solution in methods to prepare hollow-fiber membranes. The polymeric blend selected as the spinning solution may also include one or more hydrophilic polymers, solvents, and/or non-solvents. In some embodiments, the hollow-fiber membranes can be made from a homogeneous spinning solution of an aromatic sulfone polymer and a poly(2-oxazoline), and a bore liquid. The bore liquid can include water, a solvent and a non-solvent. Accordingly, the present disclosure further provides a method for producing a hollow-fiber membrane, comprising the following steps: providing a spinning solution comprising an aromatic sulfone polymer and a polyoxazoline, and a bore liquid comprising water, a solvent and a non-solvent; and spinning an aromatic sulfone polymer and poly(2-oxazoline) hollow-fiber with a spinneret outer diameter in the range of from 300 to 1000 μm, a spinneret needle outer diameter in the range of from 200 to 1000 μm and a spinneret needle inner diameter in the range of from 100 to 1000 μm.

In some embodiments, the spinning solution can further include a hydrophilic polymer. Long-chain polymers are advantageously employed as at least one hydrophilic polymer that exhibit a compatibility with the hydrophobic aromatic sulfone polymer. The aromatic sulfone polymers have repeating polymer units that in themselves are hydrophilic. The hydrophilic polymer is preferably polyvinylpyrrolidone, polyethylene glycol, polyvinyl alcohol, polyglycol monoester, a polysorbitate such as polyoxyethylene sorbitan monooleate, carboxymethylcellulose or a modification or copolymer of these polymers. Polyvinylpyrrolidone and polyethylene glycol are particularly preferred.

In some embodiments, the spinning solutions includes a polyethylene glycol (PEG). In some embodiments, the polyethylene glycol in the spinning solution can have a molecular weight (MW) from about 100 to about 1,800 g/mol. In some embodiments, the polyethylene glycol in the spinning solution can have a molecular weight (MW) of about 200, 400, 500, 600, 1000, 1200, or 1,500 g/mol.

Within the context of the present disclosure, at least one hydrophilic polymer can also comprise mixtures of different hydrophilic polymers. The hydrophilic polymer can, for example, be a mixture of chemically different hydrophilic polymers or of hydrophilic polymers with different molecular weights, e.g. a mixture of polymers whose molecular weight differs by a factor of 5 or more.

After preferably degassing and filtration to remove gasses and undissolved particles, the homogeneous spinning solution is extruded through the annular gap of a conventional hollow-fiber die in conjunction with a bore fluid to produce a hollow fiber. A bore liquid, i.e. an interior filler that is a coagulation medium for the aromatic sulfone polymer and at the same time stabilizes the lumen of the hollow-fiber, is extruded through the central nozzle opening arranged coaxially to the annular gap in the hollow-fiber die. Within the present disclosure, the terms “hollow-fiber die” and “spinneret” may be used interchangeably. The bore liquid may comprise water and glycerol but may also comprise additional ingredients and/or solvents, for example, polyethylene glycol (PEG). Preferably, the bore liquid further comprises non-solvents for the membrane-forming polymer such as water, low-molecular polyethylene glycols with a mean molecular weight of less than 1000 Daltons or low-molecular alcohols such as ethanol or isopropanol, and/or protic solvents such as ε-caprolactam. Preferably, the bore liquid comprises water, N-methylpyrrolidone and polyethylene glycol. Solvent can be present from 5 to 70 wt. %, relative to the weight of the solution.

The solvent system to be employed must be matched to the aromatic sulfone polymer employed and to the poly(2-oxazoline) so that a homogeneous spinning solution can be produced. The solvent system preferably comprises polar, aprotic solvents such as dimethylformamide, dimethylacetamide, dimethyl sulfoxide, N-methyl pyrrolidone or their mixtures, or protic solvents such as ε-caprolactam. Furthermore, the solvent system can contain up to 70 wt. % latent solvent, whereby in the context of the present invention a latent solvent is understood as a solvent that poorly dissolves the sulfone polymer or dissolves it only at elevated temperature. In cases where ε-caprolactam is used as a solvent, butyrolactone, propylene carbonate or polyalkylene glycol can be employed, for example. In addition, the solvent system can contain non-solvents for the membrane-forming polymer such as water, glycerin, low-molecular polyethylene glycols with a mean molecular weight of less than 1000 Daltons or low-molecular alcohols such as ethanol or isopropanol. Preferably, the solvent system contains N-methyl pyrrolidone.

In one embodiment, the spinning solution includes an aromatic sulfone polymer, poly(2-oxazoline), a polyethylene glycol, N-methylpyrrolidone, and water. In another embodiment, the spinning solution includes a polyethersulfone, poly(2-ethyl-2-oxazoline), polyethylene glycol, N-methylpyrrolidone, and water. In still another embodiment, the spinning solution includes a polyethersulfone, poly(2-ethyl-2-oxazoline), PEG200 or PEG1500, N-methylpyrrolidone, and water.

The width of the annular gap and the inside diameter of the central nozzle opening were selected according to the desired properties of the hollow-fiber membrane according to the present disclosure. That is, the spinneret exhibits a spinneret outer diameter for dope in the range of from 300 to 1000 μm, a spinneret needle outer diameter in the range of from 200 to 1000 μm and a spinneret needle inner diameter in the range of from 100 to 1000 μm.

After leaving the hollow-fiber die (i.e. the spinneret) and before entering a coagulation medium, the hollow-fiber may pass through a climate-controlled zone with defined climatic conditions. The climate-controlled zone can thereby take the form of e.g. an encapsulated chamber. For technical reasons it may be necessary for an air gap to exist between the hollow-fiber die and the climate-controlled zone. This gap should, however, advantageously be as small as possible; the climate-controlled zone preferably directly follows the hollow-fiber die.

In this regard, it is preferred that the hollow-fiber has a retention time in the climate-controlled zone of 0.5 to 10 seconds, whereby the climate-controlled zone contains air with a relative humidity of 20 to 95% and a temperature of 25 to 75° C. It is preferred that the retention time of the hollow-fiber in the climate-controlled zone is 0.5 to 5 seconds. In order to establish stable conditions in the climate-controlled zone, the air preferably flows through the climate-controlled zone with a velocity of less than 0.5 m/s and particularly preferably with a velocity in the range from 0.15 to 0.35 m/s.

In one embodiment, the climate-controlled zone contains air with a relative humidity of 20 to 95% and a temperature of 25 to 75° C. In one embodiment, the climate-controlled zone contains air with a relative humidity of 60 to 75% and a temperature of 30 to 50° C. In one embodiment, the climate-controlled zone contains air with a relative humidity of 75 to 90% and a temperature of 30 to 50° C. In one embodiment, the climate-controlled zone contains air with a relative humidity of 60 to 75% and a temperature of 50 to 70° C. In one embodiment, the climate-controlled zone contains air with a relative humidity of 75 to 90% and a temperature of 50 to 70° C.

As the hollow-fiber is directed through the climate-controlled zone, a precoagulation of the hollow-fiber is induced by absorption on the outside of the hollow-fiber of the water vapor acting as the non-solvent, before the coagulation of the hollow fiber. Simultaneously, the retention time should be set within the range preferred in the method according to the present disclosure. These measures influence the formation of the outer layer of the hollow-fiber membrane according to the invention so that in some embodiments, the outer layer can obtain an essentially isotropic structure.

After passing through the climate-controlled zone, the precoagulated hollow-fiber is directed through an aqueous coagulation medium preferably conditioned to 20 to 90° C. in order to complete the formation of the membrane structure. The coagulation medium is preferably conditioned to a temperature in the range from 20 to 90° C. Preferably, the coagulation medium, such as precipitation bath, is water or a water bath.

In the coagulation medium, the membrane structure is first precipitated to such an extent that it already has sufficient stability and can be diverted over e.g. deflection rollers or similar means in the coagulation medium. During the further course of the process, the coagulation is completed and the membrane structure stabilized. An extraction of the solvent system and soluble substances takes place here at the same time. In general, a large proportion of the hydrophilic polymer, is extracted from the membrane structure, so that the coagulation baths serve at the same time as washing or extraction baths. Water is preferably employed as a coagulation or washing medium in the coagulation or washing baths. In some embodiments, extraction of the solvent system and soluble substances can take place at a different step. The hollow fiber bundles can be put in a box and flushed with hot water. Majority of the hydrophilic polymer can be extracted from the membrane structure at this step.

The hollow-fiber membrane according to the present disclosure may be texturized (if necessary) to improve the exchange properties of the hollow-fiber membrane in the bundle. The membrane can be then collected. The hollow-fiber membrane can be dried. The dried membrane can be then coiled. Finally, the hollow-fiber membrane can be processed using conventional methods, e.g. wound onto a coil or formed directly into bundles with a suitable fiber count and length. Before production of the bundles, supplementary threads, e.g. in the form of multifilament yarns, can be added to the hollow-fiber membranes in order to ensure a spacing of the hollow-fiber membranes relative to one another and a better flow around the individual hollow-fiber membranes in the bundle.

According to the present disclosure, the concentration of the sulfone polymer in the spinning solution is preferably in the range of from 27 to 30 wt %. Below a concentration of 27 wt. %, disadvantages may arise with regard to virus retention. The sulfone polymer can also contain additives such as antioxidants, nucleating agents, UV absorbers, etc. to selectively modify the properties of the membranes. The concentration of poly(2-oxazolines) in the spinning solution can be in the range of from 5 to 30 wt. %.

In some embodiments, the spinning solution can have 27-30 wt %, relative to the weight of the solution, of the aromatic sulfone polymer, 7-15 wt %, relative to the weight of the solution, of a poly(2-oxazoline); 30-40 wt %, relative to the weight of the solution, of a solvent; and 25-50 wt. %, relative to the weight of the solution, of a hydrophilic polymer.

In some embodiments, the spinning solution can have 27-30 wt. %, relative to the weight of the solution, of a polyethersulfone; 10-30 wt. %, relative to the weight of the solution, of poly(2-ethyl-2-oxazoline); 50-63 wt %, relative to the weight of the solution, of N-methylpyrrolidone.

In some embodiments, the spinning solution can have 27-30 wt. %, relative to the weight of the solution, of a polyethersulfone; 5-20 wt %, relative to the weight of the solution, of poly(2-ethyl-2-oxazoline); 20-68 wt. %, relative to the weight of the solution, of N-methylpyrrolidone; and 5-40 wt. %, relative to the weight of the solution, of a polyethylene glycol.

In some embodiments, the spinning solution can have 27-30 wt. % of a polyethersulfone; 5-15 wt. % of poly(2-ethyl-2-oxazoline); 3040 wt % of N-methylpyrrolidone; and 5-40 wt % of a polyethylene glycol based on the total weight of the solution.

In some embodiments, the spinning solution can have 27-30 wt. % of a polyethersulfone; 7-12 wt. % of poly(2-ethyl-2-oxazoline); 30-35 wt. % of N-methylpyrrolidone; and 25-35 wt. % of a polyethylene glycol based on the total weight of the solution.

In some embodiments, the spinning solution can have 5-18 wt. % of poly(2-ethyl-2-oxazoline) based on the total weight of the solution. In some embodiments, the spinning solution can have 5-15 wt % of poly(2-ethyl-2-oxazoline) based on the total weight of the solution. In some embodiments, the spinning solution can have 7-12 wt. % of poly(2-ethyl-2-oxazoline) based on the total weight of the solution. In some embodiments, the spinning solution can have 8-11 wt. % of poly(2-ethyl-2-oxazoline) based on the total weight of the solution.

In some embodiments, the spinning solution can have 25-60 wt. % of N-methylpyrrolidone based on the total weight of the solution. In some embodiments, the spinning solution can have 25-50 wt % of N-methylpyrrolidone, based on the total weight of the solution.

In some embodiments, the spinning solution can have 25-40 wt. % of N-methylpyrrolidone, based on the total weight of the solution. In some embodiments, the spinning solution can have 27-30 wt. % of a polyethersulfone; and 5-15 wt. %, of poly(2-ethyl-2-oxazoline) based on the total weight of the solution.

In some embodiments, the spinning solution can have 27-30 wt. % of a polyethersulfone; and 7-12 wt. % of poly(2-ethyl-2-oxazoline) based on the total weight of the solution.

In some embodiments, the spinning solution can have 27-30 wt. % of a polyethersulfone; and 8-11 wt. % of poly(2-ethyl-2-oxazoline) based on the total weight of the solution.

In some embodiments, the spinning solution can have 20-40 wt. % of a polyethylene glycol based on the total weight of the solution. In some embodiments, the spinning solution can have 25-35 wt. % of a polyethylene glycol based on the total weight of the solution.

In some embodiments, the polyethylene glycol component of the polymeric blend or spinning solution can have a molecular weight of 200 g/mol (PEG200), a molecular weight of 400 g/mol (PEG400), a molecular weight of 600 g/mol (PEG600), a molecular weight of 1000 g/mol (PEG1000), a molecular weight of 1200 g/mol (PEG1200), or a molecular weight of 1500 g/mol (PEG1500).

In some embodiments, the polyethylene glycol component of the polymeric blend or spinning solution can have a molecular weight of 200-600 g/mol. In some embodiments, the polyethylene glycol component of the polymeric blend or spinning solution can have a molecular weight of 500-1000 g/mol. In some embodiments, the polyethylene glycol component of the polymeric blend or spinning solution can have a molecular weight of 1000-1500 g/mol.

The invention provides polymeric membranes with superior protein repelling characteristics. Therefore, these membranes block more slowly, show a higher throughput behavior and thus a longer lifetime. These membranes further exhibit an asymmetrical structure that is promising for the preparation of highly selective membranes. The protein repelling characteristics of the membranes can provide better filtration characteristics due to less fouling resulting in higher throughput.

In some embodiments, the hollow-fiber membrane of the present discourse can be suitable for use in applications in the field of filtration, for example, for filtration of antibodies including monoclonal antibodies (mAb). Due to the unique combination of properties of the hollow-fiber membrane as described herein, preferably obtained from the method as described herein, the present disclosure further provides a use of the membranes as described herein for filtration of liquids, for example, microfiltration or ultrafiltration. “Microfiltration” and “ultrafiltration” have the meaning common in the art. Preferably, the use as described herein comprises clarification and/or purification of liquid media, in particular aqueous liquids. In some embodiments, the liquids that can be filtered by the hollow-fiber membrane of the present discourse, can include a biological product selected from capsids, viruses, virus like particles or an antibody containing solution. The hollow-fiber membrane can remove more than 3, 4 log, 5 log, 6 log or 7 log reduction value (LRV) of contaminating bacteriophages or viruses that are 15 nm or greater. The hollow-fiber membrane can be operated using either constant flow rate or a constant pressure. These membrane attributes enable faster processing times and more flexibility in the processing equipment that is used to perform the filtration, and the ability to be operated under a variety of conditions.

In some embodiments, the present discourse provides a method. The method can include flowing an antibody containing solution through the hollow-fiber membrane of the present discourse; and collecting the antibody. Viruses or bacteriophages that are 15 nm or greater can be at least partially removed from the antibody containing solution. In some embodiments, the antibody containing solution can be a concentrated antibody solution in a concentration more than 50 mg/ml.

### Exemplary Embodiments

Embodiment 1 is a hollow-fiber membrane; the hollow-fiber membrane made from a polymeric blend comprising an aromatic sulfone polymer and a polyoxazoline, wherein the polymeric blend comprises from 27 wt. % to 30 wt. % aromatic sulfone polymer, based on the total weight of the polymeric blend; wherein the hollow-fiber membrane comprises an inner surface facing towards its lumen, an outer surface facing outwards and an intermediate wall having a wall thickness; wherein the hollow-fiber membrane is an integrally asymmetric, permeable hollow-fiber membrane.

Embodiment 2 is the hollow-fiber membrane of embodiment 1, wherein the aromatic sulfone polymer comprises a polysulfone or polyethersulfone.

Embodiment 3 is the hollow-fiber membrane of any of embodiments 1 to 2, wherein the polyoxazoline is poly(2-ethyl-2-oxazoline) (PEtOx).

Embodiment 4 is the hollow-fiber membrane of any of embodiments 1 to 3, wherein a zone with minimum pore size adjoins the inner surface.

Embodiment 5 is the hollow-fiber membrane of embodiment 4, wherein a zone with maximum pore size adjoins the outer surface.

Embodiment 6 is the hollow-fiber membrane of any of embodiments 1 to 3, wherein a zone with minimum pore size adjoins to the outer surface.

Embodiment 7 is the hollow-fiber membrane of embodiment 6, wherein a zone with maximum pore size adjoins the inner surface.

Embodiment 8 is the hollow-fiber membrane of any of embodiments 4 to 7, wherein the size of the pores in the zone with minimum pore size is in the range of from 10 nm to 20 nm.

Embodiment 9 is the hollow-fiber membrane of any of embodiments 4 to 8, wherein at least some pores of the zone with minimum pore size or the zone with maximum pore size are connected.

Embodiment 10 is the hollow-fiber membrane of embodiment 9, wherein at least some pores of the zone with minimum pore size or the zone with maximum pore size are connected through channels between pores.

Embodiment 11 is the hollow-fiber membrane of any of embodiments 1 to 10, wherein the hollow-fiber membrane comprises tortuous structures extending in the hollow-fiber membrane.

Embodiment 12 is the hollow-fiber membrane of embodiment 11, wherein at least some of the tortuous structures extends from the inner surface toward to the outer surface.

Embodiment 13 is the hollow-fiber membrane of any of embodiments 1 to 12, wherein the polymeric blend comprising more than 7 wt. % or less than 3 wt. % of polyvinylpyrrolidone.

Embodiment 14 is the hollow-fiber membrane of any of embodiments 1 to 13, wherein the polymeric blend does not comprise polyvinylpyrrolidone.

Embodiment 15 is the hollow-fiber membrane of any of embodiments 4 to 10, wherein the zone with minimum pore size has a lower flow rate than the zone with maximum pore size.

Embodiment 16 is the hollow-fiber membrane of any of embodiments 4 to 10, wherein the zone with minimum pore size (retention layer) has a thickness of 5 to 100 μm.

Embodiment 17 is the hollow-fiber membrane of any of embodiments 1 to 16, wherein the hollow-fiber membrane has a more than 3 log reduction value (LRV) of viruses or bacteriophages that are 15 nm or greater.

Embodiment 18 is the hollow-fiber membrane of any of embodiments 1 to 17, wherein the hollow-fiber membrane is capable of removing viruses or bacteriophages that are 15 nm or greater.

Embodiment 19 is a use of the hollow-fiber membrane of any of embodiments 1 to 18 for filtration of antibodies.

Embodiment 20 is a method, the method comprising of flowing an antibody containing solution through the hollow-fiber membrane of any of embodiments 1 to 18; and collecting the antibody.

Embodiment 21 is the method of embodiment 20, wherein viruses or bacteriophages that are 15 nm or greater 20 are removed from the antibody containing solution.

Embodiment 22 is the method of any of embodiments 20 to 21, wherein the antibody containing solution is a concentrated antibody solution.

Embodiment 23 is a porous hollow-fiber membrane comprising: an aromatic sulfone polymer and a polyoxazoline; an inner surface facing towards the hollow-fiber membrane lumen, an outer surface facing outwards, and an intermediate wall having a wall thickness; wherein a first cross section zone begins at the inner surface and extends laterally into the interior of the intermediate wall terminating at an internal distance within the intermediate wall and pore size progressively decreases across the first cross section zone in the direction from the inner surface to the outer surface; wherein the hollow-fiber membrane has a second cross section zone that begins where the first cross section zone terminates and extends laterally to the outer surface of the membrane and pore size progressively increases across the second cross section zone in the direction from the beginning of the second cross section zone to the outer surface.

Embodiment 24 is a porous hollow-fiber membrane according to embodiment 23, wherein the pore size at the outer surface is smaller than the pore size at the inner surface.

Embodiment 25 is a porous hollow-fiber membrane according to any of embodiments 23 to 24, wherein the pores located where the first cross section zone terminates and the second cross section zone begins form at least a portion of a retention zone.

Embodiment 26 is a porous hollow-fiber membrane according to any of embodiments 23 to 25, wherein the pores located where the first cross section zone terminates and the second cross section zone begins have pore sizes of less than 0.035 micrometers.

Embodiment 27 is a porous hollow-fiber membrane according to any of embodiments 23 to 26, wherein the pores located where the first cross section zone terminates and the second cross section zone begins have pore sizes of less than 0.03 micrometers.

Embodiment 28 is a porous hollow-fiber membrane according to any of embodiments 23 to 27, wherein the pores located where the first cross section zone terminates and the second cross section zone begins have pores sizes of about 0.01-0.035 micrometers.

Embodiment 29 is a porous hollow-fiber membrane according to any of embodiments 23 to 28, wherein the pores located where the first cross section zone terminates and the second cross section zone begins have pores sizes of about 0.01-0.03 micrometers.

Embodiment 30 is a method comprising: flowing a liquid containing an antibody and a virus through a porous hollow-fiber membrane; wherein the hollow-fiber membrane comprises an aromatic sulfone polymer and a polyoxazoline; wherein the hollow-fiber membrane comprises an inner surface facing towards the hollow-fiber membrane lumen, an outer surface facing outwards, and an intermediate wall having a wall thickness; wherein a first cross section zone begins at the inner surface and extends laterally into the interior of the intermediate wall terminating at an internal distance within the intermediate wall; wherein pore size progressively decreases across the first cross section zone in the direction from the inner surface to the outer surface; wherein the hollow-fiber membrane has a second cross section zone that begins where the first cross section zone terminates and extends laterally to the outer surface of the membrane; wherein pore size progressively increases across the second cross section zone in the direction from the beginning of the second cross section zone to the outer surface; and collecting the liquid.

Embodiment 31 is a method comprising: flowing a liquid containing an antibody and a virus through a porous hollow-fiber membrane; wherein the hollow-fiber membrane comprises an aromatic sulfone polymer and a polyoxazoline; wherein the hollow-fiber membrane comprises an inner surface facing towards the hollow-fiber membrane lumen, an outer surface facing outwards, and an intermediate wall having a wall thickness; wherein a first cross section zone begins at the inner surface and extends laterally into the interior of the intermediate wall terminating at an internal distance within the intermediate wall; wherein pore size progressively decreases across the first cross section zone in the direction from the inner surface to the outer surface; wherein the hollow-fiber membrane has a second cross section zone that begins where the first cross section zone terminates and extends laterally to the outer surface of the membrane; wherein pore size progressively increases across the second cross section zone in the direction from the beginning of the second cross section zone to the outer surface; retaining at least a portion of the virus in the membrane; and collecting the liquid from the membrane.

Embodiment 32 is a method according to any of embodiments 30 to 31, wherein the pore size at the outer surface is smaller than the pore size at the inner surface.

Embodiment 33 is a method according to any of embodiments 30 to 32, wherein virus is removed from the liquid.

Embodiment 34 is a method according to any of embodiments 30 to 33, wherein at least a 3 log reduction value (LRV) of virus is removed from the liquid.

Embodiment 35 is a method according to any of embodiments 30 to 34, wherein at least a 4 log reduction value (LRV) of virus is removed from the liquid.

Embodiment 36 is a method according to any of embodiments 30 to 35, wherein the liquid is water.

Embodiment 37 is a method according to any of embodiments 30 to 36, wherein the virus is 15 nm or greater in diameter.

Embodiment 38 is a method according to any of embodiments 30 to 37, wherein the virus is 15-30 nm in diameter.

Embodiment 39 is a method according to any of embodiments 30 to 38, wherein the antibody is 5-10 nm in diameter.

Embodiment 40 is a method according to any of embodiments 30 to 39, wherein the pores located where the first cross section zone terminates and the second cross section zone begins form at least a portion of a retention zone.

Embodiment 41 is a method according to the eighth through eighteenth embodiments, wherein virus is retained in the retention zone.

Embodiment 41 is an article comprising the porous hollow-fiber membrane according to any of embodiments 1 to 18 and 23 to 29.

The following working examples are intended to be illustrative of the present disclosure and not limiting.

### EXAMPLES

Objects and advantages of this invention are further illustrated by the following examples, but the particular materials and amounts thereof recited in these examples, as well as other conditions and details, should not be construed to unduly limit this invention.

The following abbreviations are used herein: mL=milliliters, L=liters, kg=kilograms, g=grams, mg=milligrams, m=meters, cm=centimeters, mm=millimeters, nm=nanometers, s=seconds, min=minutes, hr=hours, psi=pounds per square inch, and wt. %=percent by weight.

Scanning electron microscope (SEM) images were obtained using an FEI 250 scanning electron microscope with xT Microscope Control operating software (Thermo Fisher Scientific, Waltham, MA), or a Coxem EM-30AX scanning electron microscope with NanoStation operating software (Coxem Company, Daejeon, Korea).

TABLE 1
Materials List

| Description (Abbreviation) | Source |
|---|---|
| Polyethersulfone (PES), (ULTRASON | BASF SE, Ludwigshafen, |
| E6020), (MW = 72,000 g/mol) | Germany |
| Poly(2-ethyl-2-oxazoline) (PEtOx) | Polymer Chemistry Innovations, |
| (MW = 50,000 g/mol) | Tucson, AZ |
| Poly(ethylene glycol) 200 (PEG200) | VMP Chemiekontor GmbH, |
| (MW = 200 g/mol) | Siegburg, Germany |
| N-Methylpyrrolidone (NMP) | Ashland Inc., Wilmington, DE |

### Method A. Method for Determining Transmembrane Flow (TMF)

A hollow-fiber membrane test module was prepared by placing ten hollow-fiber membranes (10 cm in length) in a straight, cylindrical polycarbonate tube (inner diameter of 8 mm and a length of 60 mm). The tube had a side-positioned outlet located about midway between the two ends of the cylinder. The hollow-fiber membranes were imbedded in the tube using hot melt glue at both ends of the tube. After solidification, the protruding ends of the hollow-fiber membranes and excess glue were removed using a razor blade. The openings of the membranes were visually inspected and only modules in which all of the hollow-fiber membranes had open and unobstructed lumen portions were used. The polycarbonate tube was capped at each end with caps having a port for attachment to flexible tubing. The finished test module was attached to a stand, placed in a vertical orientation, filled with 18 megaohm water, and connected to a measuring system.

The measuring system included a pressure pot filled with 18 megaohm water that was connected to one end of the test module with flexible tubing, two pressure gauges (the first pressure gauge located between the pressure pot and the test module and the second pressure gauge positioned downstream from the opposite end of the module), and a flush valve positioned downstream from the module and the second pressure gauge. The measuring system also included a heater that the water passed through that was located between the pressure pot and the first pressure gauge. The heater warmed the water to 25° C.

A pressure of 5.8 psi was applied to the pressure pot. At the start of the test, the air in the system was displaced by closing the side outlet and opening the flush valve. The flush valve was then closed and the side outlet opened to operate the module in a dead-end filtration configuration. Water flowed for four minutes from the pressure pot through the lumen of the membranes, filtering through the membrane walls, and exiting the module through the side outlet into a first collection vessel. The first collection vessel was then replaced with a tared second collection vessel. The filtered water was collected in the second collection vessel for 60 seconds. The amount of water collected in the second vessel was determined using a digital balance. The differential pressure was determined by reading the difference between the two pressure gauges.

Based on the dimensions of the membrane, the differential pressure, and the weight of the water, the transmembrane flow (TMF) was calculated according to Equation 1.

$$TMF [ \frac{mL}{{cm}^{2} \cdot min \cdot bar} ] = \frac{{m}_{W} / {ρ}_{w}}{[ Δ t \cdot {A}_{M} \cdot Δ p ]} \qquad Equation 1$$

where:
m_{W}=amount of water (in grams) passed through the membrane sample during the measuring period
ρ_{w}=Density of water at 25° C.
Δt=Measuring time (minutes)
A_{M}=Total inner surface area of hollow membrane in the test module
Δp=Differential pressure along the length of the test module (bar)

### Method B. Method for Determining the Viscosity of a Spinning Solution (Polymeric Blend)

The viscosity of a casting solution was determined at 60° C. and a shear rate of 10 s⁻¹ using a HAAKE RheoStress 1 rheometer (Thermo Fisher Scientific, Waltham, MA) with a Z20DIN sensor device (Thermo Fisher Scientific).

### Method C. Phi-X174 Phage Culture Preparation

Phi-X174 bacteriophage (ATCC 13706-B1) was obtained from ATCC (Manassas, VA). The phage culture was produced by growing a 1 L culture of E. coli (ATCC 13706) in CRITERION Nutrient Broth (Hardy Diagnostics, Santa Maria, CA) plus 5% sodium chloride at 37° C. with mixing at 210 revolutions per minute (rpm) to an OD of 0.45. The culture was inoculated with about 1,000 plaque-forming units (pfu) of Phi-X174 phage. The inoculated culture was grown for an additional 4 hours at 37° C. with mixing at 210 rpm. The inoculated Phi-X174 culture was then purified using anion exchange chromatography. The purified Phi-X174 was sterile filtered through a 0.2 micron syringe filter. The phage concentration was determined per Method D and was stored at 4° C.

### Method D. Determination of Phi-X174 Phage Concentration

The phage concentration of filtrate samples, feed solutions, and Phi-X174 culture preparations was determined using the following procedure. The solutions of interest were serially diluted (10-fold). Top agar (CRITERION Nutrient Broth (Hardy Diagnostics) with 0.9% agar, 2.5 mL) was mixed with 50 microliters of E. coli (ATCC 13706) culture (in CRITERION Nutrient Broth plus 5% sodium chloride grown at 37° C. with shaking at 210 rpm overnight) and 100 microliters of diluted Phi-X174 phage. The mixture was poured on top of a standard nutrient agar plate (CRITERION nutrient broth with 1.5% agar) and incubated for 3-4 hours at 37° C. Following incubation, the plaque-forming units (pfu) were counted. The number of pfu was correlated with phage particle number. The phage particle concentration (particles/mL) was calculated from the pfu count adjusted for dilution. Log reduction values (LRV) were determined by the difference in the number of plaques present in the feed solution and the number of plaques present in the filtrate (see Equation 2). A designation of “>” for a reported LRV indicates that no pfu were observed for any of the serial dilution samples of the filtrate.

$$LRV = log 10 [ \frac{concentration of Phage in the Feed Solution}{concentration of Phage in the Filtrate} ] \qquad Equation 2$$

### Method E. Porcine Circovirus (PCV2d) Preparation

Porcine circovirus (1000 mL of PCV2d USA/NC24897/2016 P14 variant, 5.62×10⁶ TCID50/mL) was centrifuged at 4,200 g for 15 minutes to remove cell debris. The supernatant was collected and centrifuged at 35,000 rpm for 2 hours using a Type 45 TI rotor and Optima XPN-100 ultracentrifuge (Beckman Coulter, Indianapolis, IN). The virus pellet was resuspended in 5.7 mL of phosphate buffer (25 mM, 4 mS/cm). After resuspension the solution was centrifuged at 1000 g for 10 minutes to remove any undissolved particles. A total of 5.5 mL of suspended virus was collected. A 20 microliter aliquot of the suspension was diluted into 180 microliters of phosphate buffered saline (PBS, 1×) for virus TCID50 titration in PK-15 cells. The concentration of the suspended virus was determined to be 4.64×10⁷ TCID50/mL. The PCV2d virus was diluted into a total of 20 mL of PBS (1×) and filtered through a BC1 EMPHAZE AEX Hybrid Purifier (3M Company, Maplewood, MN). The PCV2d concentration after filtration was 3.16×10⁶ TCID50/mL The stock solution was stored frozen.

### Example 1

A spinning solution was prepared by vigorously mixing 27 wt. % polyethersulfone, 9 wt % poly(2-ethyl-2-oxazoline), 32.4 wt. % N-methylpyrrolidone, 29.6 wt. % poly(ethylene glycol) 200 (PEG200), and 2 wt. % ultra-pure deionized water at a temperature of about 55° C. The resulting spinning solution was cooled to about 50° C., filtered, and degassed. A temperature controlled spinneret (35° C.) having an outer diameter for dope of 0.41 mm, a needle outer diameter of 0.3 mm and a spinneret needle inner diameter of 0.15 mm was used. The spinneret was fixed at a distance of 25 cm above the precipitation bath.

Using the above-mentioned spinning solution and a mixture of NMP:polyethylene glycol(PEG200):water (50:45:5) as the bore liquid in the spinneret needle of the spinneret, a hollow fiber was generated. The hollow fiber was transferred into a water-containing precipitation bath heated to about 35° C. Directly after this coagulation and fixation step, the wet hollow-fiber membranes were wound on a wheel and then assembled into a hollow-fiber membrane bundle having a length of about 30 cm and comprising about 1200 individual hollow-fiber membranes. The hollow-fiber membranes were extracted with hot water (about 90° C.) for about one hour and then dried with air at about 90° C. for about one hour. The hollow-fiber membranes obtained had a physical inner diameter of about 200 micrometers and a wall thickness of about 60 micrometers.

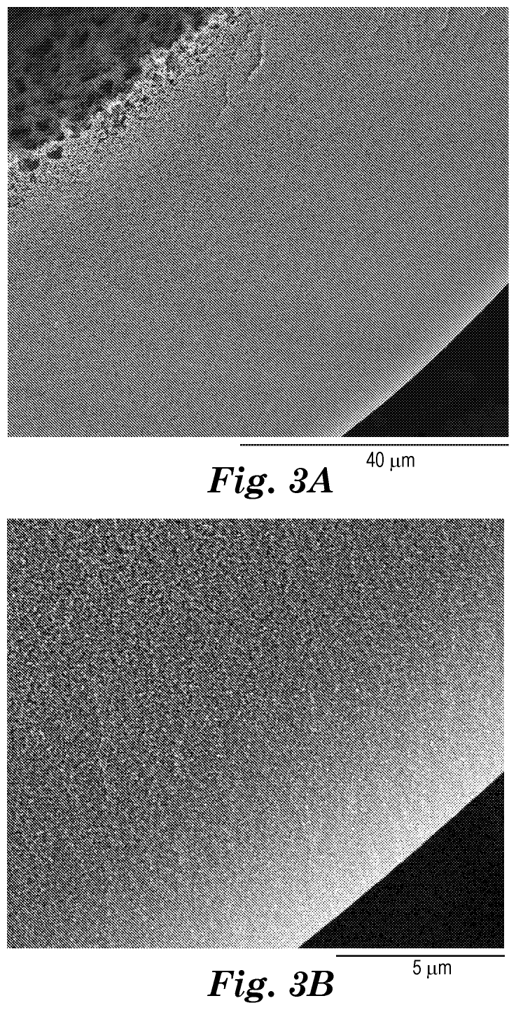

Membrane wall cross-sections were examined using a SEM (8,000-20,000× magnification). Scanning electron microscope (SEM) images of cross-sections of the hollow-fiber membrane are shown in FIG. 3A and FIG. 3B. For the membranes prepared, the pore size at the inner surface facing the lumen was about 0.06-3 micrometers. The pore size progressively decreased in the direction from the inner membrane surface to the outer membrane surface for a distance of about 57 micrometers (95%) across the membrane wall (the measurement of pore size was made along a vector that defined the shortest cross-section distance from the inner membrane surface to the outer surface of the membrane). The pore size then transitioned to progressively increase in size (along the same vector direction) toward the outer surface with the pore size at the outer membrane surface being about 0.05-0.2 micrometers. The pore size at the location in the membrane wall where the pore size transitioned from decreasing to increasing was less than 0.03 micrometers.

The transmembrane flow (TMF) values were measured according to Method A and the results are reported in Table 1.

### Example 2. Filtration of mAb Solution

A 5 mg/mL solution of mAb in Tris-HCl buffer (pH of 7 and conductivity of 5 mS/cm) was prepared from a Chinese hamster ovary (CHO) suspension cell culture expressing a biosimilar IgG1 mAb (pI of about 7.9). The mAb solution was filtered using a 3M Polisher ST BC4 capsule (3M Company) followed by a 0.2 micron PES membrane filter. The mAb solution was stored at 4° C. until used. The concentration of the mAb was determined by measuring absorbance of the solution at 280 nm and comparing the result to a previously prepared standard concentration curve.

Hollow-fiber membrane test modules were prepared and tested according to the following procedure. Polycarbonate tubes with lengths of 30 mm and inner diameters of 4 mm were used. A single hole was drilled in the side of each tube. An open-bore connector was attached to the hole using a uv/visible light cured adhesive to form a side port. A cap was attached to the side port. About 25-30 hollow-fibers prepared according to Example 1 were placed in each tube. The inserted hollow-fibers were cut with a razor blade to provide an overhang of hollow-fibers of about 15 mm at each end of the tube. The overhanging hollow-fibers were sealed with wax and then potted in the tube using a polyurethane resin. After curing for 24 hours, the protruding ends were removed using a razor blade. The openings of the membranes were inspected using a microscope and only tubes in which all the hollow-fiber membranes had open and unobstructed lumen portions were used. Caps having an open port for attachment to flexible tubing were secured with glue to each end of the polycarbonate tube. The total inner hollow-fiber surface area (i.e., total lumen surface area) was about 5 cm². Test modules were sterilized using gamma irradiation (2545 kGy) prior to being used.

The finished test module was attached to a stand and placed in a vertical orientation. The open port of the cap at the bottom of the module was connected using flexible tubing to a three-way valve that was located at the bottom of a vertically mounted pressure pot. The pressure pot was initially filled with ultrapure water (obtained from a MILLI-Q water purification system, EMD Millipore, Billerica, MA). The three-way valve between the pressure pot and test module was opened allowing the water to flow into the lumens of the hollow-fibers and out the opposite end of the module. When the lumens of the hollow-fibers were filled with water, the open port at the upper end of the test module was capped. The pressure was gradually increased to 30 psi. The cap on the side port of the test module was removed allowing the filtrate to exit the module into a first collection vessel. The water was filtered through the hollow-fiber module for a minimum of 10 minutes at 30 psi. The three-way valve at the bottom of the pressure pot was then closed and any remaining water in the pressure pot was removed.

The pressure pot was depressurized and filled with the 5 mg/mL mAb solution. The pressure pot was then sealed, pressurized to 30 psi, and the three-way valve was opened. The filtrate was collected in a tared, second collection vessel that was placed on a digital balance and the filtrate weight was recorded every 10 seconds. The filtration was carried out for 150 minutes. The flux (380 LMH) of the mAb solution remained constant throughout the filtration period. The ratio of the flux at 150 minutes to the flux at 60 minutes was 1.0. The ratio of the flux at 60 minutes to the flux at 20 minutes was 1.0. The total mAb filtered over 150 minutes was calculated to be 5.0 kg/m².

### Example 3. Filtration of mAb Solution Spiked with Phi-X174 Phage

The same method as described in Example 2 was followed with the exception that the 5 mg/mL solution of mAb was spiked with 10⁷ pfu/mL Phi-X174 phage.

The filtrate was collected in a tared, second collection vessel that was placed on a digital balance and the filtrate weight was recorded every 10 seconds. The filtration was carried out for 60 minutes. The flux (380 LMH) of the spiked mAb solution remained substantially constant throughout the filtration period. The ratio of the flux at 60 minutes after starting filtration to the flux at 20 minutes was 0.97. The total mAb filtered in the 60 minutes was calculated to be 1.9 kg/m². The LRV of the Phi-X174 phage filtered through the membrane is reported in Table 1.

### Example 4. Filtration of PCV2d

A 6 mL sample of PCV2d (described above, 3.16×10⁶ TCID50/mL) was diluted with 143 g of PBS (1×). The same method as described in Example 2 was followed with the exception that_the total inner hollow-fiber surface area (i.e., total lumen surface area) was about 1 cm² and either 4.5 or 10 mL of the PCV2d solution was filtered through the test module.

The concentration of PCV2d in the feed solution was compared to the concentration of PCV2d in the filtrate (using PK-15 cells to determine the TCID50/mL) and the LRV for the virus was calculated. Results are reported in Table 1.

TABLE 1
Test Results for Hollow-Fiber Membranes of Example 1

| Precipitation | | | |
|---|---|---|---|
| Bath Temperature | TMF | | |
| in Hollow- | Measurement | | |
| Fiber Membrane | (mL/(cm² · | LRV for | LRV for |
| Preparation (° C.) | min · bar)) | Phi-X174 | PCV2d |
| 35 | 0.18 | 6 | 3 (4.5 mL |
| | | | filtered) |
| 40 | 0.26 | >5.7 | 0.3 (10 mL |
| | | | filtered) |

All references and publications cited herein are expressly incorporated herein by reference in their entirety into this disclosure. Illustrative embodiments of this invention are discussed and reference has been made to possible variations within the scope of this invention. For example, features depicted in connection with one illustrative embodiment may be used in connection with other embodiments of the invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof.

1. A hollow-fiber membrane;
the hollow-fiber membrane made from a polymeric blend comprising an aromatic sulfone polymer and a polyoxazoline, wherein the polymeric blend comprises from 27 wt. % to 30 wt. % aromatic sulfone polymer, based on the total weight of the polymeric blend;
wherein the hollow-fiber membrane comprises an inner surface facing towards its lumen, an outer surface facing outwards and an intermediate wall having a wall thickness;
wherein the hollow-fiber membrane is an integrally asymmetric, permeable hollow-fiber membrane.

2. The hollow-fiber membrane of claim 1, wherein the aromatic sulfone polymer comprises a polysulfone or polyethersulfone.

3. The hollow-fiber membrane of claim 1, wherein the polyoxazoline is poly(2-ethyl-2-oxazoline) (PEtOx).

4. The hollow-fiber membrane of claim 1, wherein a zone with minimum pore size adjoins the inner surface.

5. The hollow-fiber membrane of claim 4, wherein a zone with maximum pore size adjoins the outer surface.

6. The hollow-fiber membrane of claim 1, wherein a zone with minimum pore size adjoins to the outer surface.

7. The hollow-fiber membrane of claim 6, wherein a zone with maximum pore size adjoins the inner surface.

8. The hollow-fiber membrane of claim 4, wherein the size of the pores in the zone with minimum pore size is in the range of from 10 nm to 20 nm.

9. The hollow-fiber membrane of claim 4, wherein at least some pores of the zone with minimum pore size or the zone with maximum pore size are connected.

10. The hollow-fiber membrane of claim 9, wherein at least some pores of the zone with minimum pore size or the zone with maximum pore size are connected through channels between pores.

11. The hollow-fiber membrane of claim 1, wherein the hollow-fiber membrane comprises tortuous structures extending in the hollow-fiber membrane.

12. The hollow-fiber membrane of claim 11, wherein at least some of the tortuous structures extends from the inner surface toward to the outer surface.

13. The hollow-fiber membrane of claim 1, wherein the polymeric blend comprising more than 7 wt. % or less than 3 wt. % of polyvinylpyrrolidone.

14. The hollow-fiber membrane of claim 1, wherein the polymeric blend does not comprise polyvinylpyrrolidone.

15. The hollow-fiber membrane of claim 4, wherein the zone with minimum pore size has a lower flow rate than the zone with maximum pore size.

16. The hollow-fiber membrane of claim 4, wherein the zone with minimum pore size (retention layer) has a thickness of 5 to 100 μm.

17. The hollow-fiber membrane of claim 1, wherein the hollow-fiber membrane has a more than 3 log reduction value (LRV) of viruses or bacteriophages that are 15 nm or greater.

18. The hollow-fiber membrane of claim 1, wherein the hollow-fiber membrane is capable of removing viruses or bacteriophages that are 15 nm or greater.

19. A use of the hollow-fiber membrane of claim 1 for filtration of antibodies.

20. A method, the method comprising of
flowing an antibody containing solution through the hollow-fiber membrane of claim 1; and
collecting the antibody.

21. (canceled)

22. (canceled)
